(19) United States
(12) Patent Application Publication
(10) Pub. No.: US 2020/0068926 A1
(43) Pub. Date: Mar. 5, 2020

(54) HIGH CAPACITY, SILENT, SPACE SAVING DEHYDRATOR

(71) Applicants: Alan BACKUS, Los Angeles, CA (US); Iulius MARICI, Henderson, NV (US)

(72) Inventors: Alan BACKUS, Los Angeles, CA (US); Iulius MARICI, Henderson, NV (US)

(21) Appl. No.: 16/663,739

(22) Filed: Oct. 25, 2019

Related U.S. Application Data
(63) Continuation-in-part of application No. 15/258,453, filed on Sep. 7, 2016.

(51) Int. Cl. A23L 3/40; A23B 7/02

(52) U.S. Cl. CPC A23L 3/40; B09B 3/0058; A23B 7/02

(57) ABSTRACT

A food dehydration device which can dry comestibles as well as other items utilizing electric and/or solar power. Drying trays may be disposed vertically or horizontally. Units may be stacked vertically to expand capacity. For food storage, drying trays may fit into standard zip plastic bags, without need of unloading. Drying trays may be sized similar to standard dinner plates to fit more easily into dishwashers, over countertop cabinets. Variable venting resists rain and other liquids from the drying cavity. A hand-operated pusher device may be used to impale foods onto posts to load the drying trays. Trays may include orthogonal posts to impale and/or open-air suspend on the tips of posts, articles being dried, such as fruit rollup trays, yogurt cups, herbs, seeds, or nuts. Embodiments may be stored on their side to reduce storage shelf height requirements suitably including nonstick coating.

### REFERENCE TO RELATED APPLICATIONS

This application is a Continuation-in-Part to U.S. patent application Ser. No. 15/258,453, filed Sep. 7, 2016, the content of which is also incorporated herein by reference.

### TECHNICAL FIELD

The inventions described herein are related to devices to dehydrate comestibles and other items.

### BACKGROUND

Dehydration is among the oldest forms of food preservation, dating back to prehistoric times.

In recent years, there has been a resurgence in home food dehydration devices, with one large Internet retailer selling over 50 different models. Generally, these models have one or more of the following deficiencies: they are too large to be conveniently used in most home kitchens; they are too small to have adequate capacity for taking advantage of store specials or a bounty crop; they are too noisy, having fan driven circulation systems; they are complicated to use, requiring tray rotation, and careful timing; and, they are too inconvenient, having trays which are difficult to fit into many dishwashers or into over-counter or pantry cabinets.

### BRIEF DESCRIPTION OF THE DRAWINGS

Various embodiments will become better understood with regard to the following description, appended claims and accompanying drawings wherein:

FIG. 1 is a perspective view of embodiment 100, with trays 102 (also referred to herein as typical drying shelves 106) mounted vertically into drying cavity 104.

FIG. 2 is a perspective view of embodiment 100, with trays 102 mounted horizontally into drying cavity 104.

FIG. 3 is a perspective view of a conventional method of expanding food dehydrator capacity.

FIG. 4 is a perspective view of a method of expanding dehydrator capacity, utilizing embodiment 100.

FIG. 5 shows a perspective of typical drying shelf 106 being inserted into standard zip bag 108.

FIG. 6 is a perspective showing a comparison between the size of a typical dinner plate and embodiment 100.

FIG. 7 is a perspective of embodiment 100 placed in kitchen environment 110.

FIG. 8 is a frontal exploded perspective of embodiment 100.

FIG. 9 is an exploded perspective taken from below and behind embodiment 100.

FIG. 10 is an enlarged detail of FIG. 8, as indicated in FIG. 8.

FIG. 11 is an exploded detail of FIG. 9, as indicated in FIG. 9.

FIG. 12 is a forward perspective of embodiment 100, with typical drying shelf 106, and drip pan 112 partially pulled out of cabinet 114.

FIG. 13 is a perspective of typical drying shelf 106 with posts 116 facing up 118, and with shelf 106 flipped over 127 with posts 116 facing down 120.

FIG. 14 is a perspective of typical drying shelf 106 with posts 116 facing up 118, and food 122 resting on the upward tips of posts 116.

FIG. 15 is a perspective of typical drying shelf 106 with posts 116 facing up 118, and food 122 impaled on the upward tips of posts 116.

FIG. 16 is a perspective of typical drying shelf 106 with posts 116 facing down 120, and food 122 resting on the generally flat rear surface 121 of drying shelf 106.

FIG. 17 is a perspective of typical drying shelf 106 disposed vertically, with food 122 impaled on the tips of posts 116.

FIG. 18 is a perspective of food 122 resting on the upward tips of posts 116, and being pressed down 123 by pusher 124 to be impaled on the upward tips of posts 116.

FIG. 19 is a perspective of embodiment 100 in both its vertical storage/operation position 125, and its tipped over storage position 126.

FIG. 20 is a perspective of embodiment 128 which is a food mounting system which includes one, or a plurality of typical drying shelves 106, mounted into shelf support 130, and holding food, or other articles to be processed 131, in a generally vertical disposition.

FIG. 21 is a perspective of kitchen environment 132 showing non-limiting and non-exhaustive examples of where embodiment 128 might be employed. Embodiment 128 may be used in an oven or convection oven 134, or in a microwave 136, or in a refrigerator or freezer 138. This also includes a food mounting rack which is immersed into boiling or hot water, or hot oil, or other hot fluid.

FIG. 22 is a perspective of embodiment 140 which is a food mounting system similar to embodiment 128, which can be used in similar applications. Embodiment 140 includes one, or a plurality of typical drying shelves 106, mounted into shelf support 142. Shelf support 142 is configured to both hold typical drying shelves 106 in a generally vertical disposition 144, as well as in a tipped back inclined disposition 146. Useful inclinations range from 30° above horizontal to up to 90° above horizontal. This inclined disposition may better support articles being processed as well as improve the processing.

FIG. 23 is a perspective of embodiments 100, with drying shelves in their vertical disposition (FIG. 1), showing its relative: outer size, countertop footprint, and internal capacity; when compared with a typical 6 tray round food dehydrator 148, or a typical 6 tray box food dehydrator 150. FIG. 23 shows embodiment 100 may have a smaller countertop footprint than either typical round 148 or box 150 food dehydrators. Capacity is shown by 1.8 inch diameter apple slices 152 that can be fit into each unit, laid out in front of each unit. Due at least in part to vertical mounting of food and other articles, which allows for food to be more densely packed into embodiment 100, embodiment 100 may have up to twice the capacity or more of much larger competitive food dehydrators.

FIG. 24 is a perspective showing typical drying shelf 106 with posts 116 pointing up 118 and supporting fruit rollup tray 152. This posts 116 up 118 arrangement may be used for other items to be processed, including, as non-limiting and non-exhaustive examples, yogurt cups, cooking parchment, and other items; and may allow better air circulation around rollup tray 152 as well as other items.

FIG. 25 is a perspective showing typical drying shelf 106 with posts 116 facing up 118 and supporting herbs 154. Although herbs 154 and other items may be supported on the generally flat rear surface 121 (FIG. 16) of shelf 106 when posts 116 are facing down 120 (FIG. 16), placing the herbs on drying shelf 106 when posts 116 are facing up 118 may allow faster and more even drying, or processing, by causing better air circulation around herbs 154 as well as other items.

FIG. 26 is a perspective of embodiment 228, with FIG. 27 being a detail of FIG. 26, as indicated in FIG. 26. In general, trays 102 may be fabricated using a variety of manufacturing techniques. As non-limiting and non-exhaustive examples, embodiment 100 may be: injection molded, compression molded, CNC'd (computer generated), cast, die cast, or made with other suitable manufacturing process.

FIG. 27 shows an alternative form of construction for trays 102. Here, posts 230 (FIG. 27) in embodiment 228 substitute for posts 116 in trays 102, and are formed by stamping them out of flat sheet 232, which can be metal or other suitable material.

Stamping embodiment 228 out of metal or other high temperature material, may at least allow it, as a non-limiting and non-exhaustive example, to be suitable for use in high temperature environments such as, as non-limiting and non-exhaustive examples, in a bake oven, or in frying oil, or boiling water, or in a convection oven, or air fryer, or other suitable environments.

This stamping construction also may allow perforations 234 which permit fluid circulation through embodiment 228, in a manner similar to perforated central portion 172 in drying shelf 106 (FIG. 13).

Further, stamping may allow for rolled edge 236 which may strengthen, stiffen, and soften the edges of embodiment 228.

Like trays 102, embodiment 228 may be symmetrical side to side and/or up and down, or both, allowing it to be inserted into drying cavity 104 with minimum regard to orientation.

Embodiment 228 may be constructed of a wide variety of materials, including, but not limited to: steel, stainless steel, aluminum, or other suitable material. It has been found that nonstick coating the exterior surfaces of embodiment 228 greatly improves its functionality.

### SUMMARY

Embodiment 100 is a food dehydration device having the following features:

Compact size, with a small countertop footprint (FIG. 23).

Large capacity, which far exceeds most other countertop food dehydrators (FIG. 23).

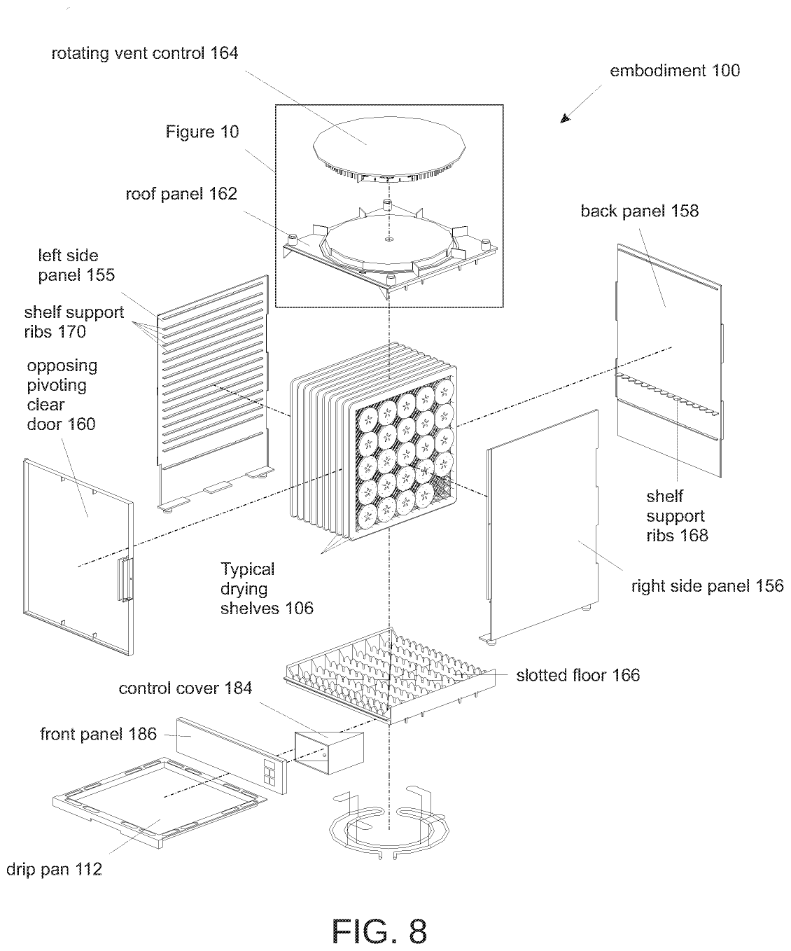

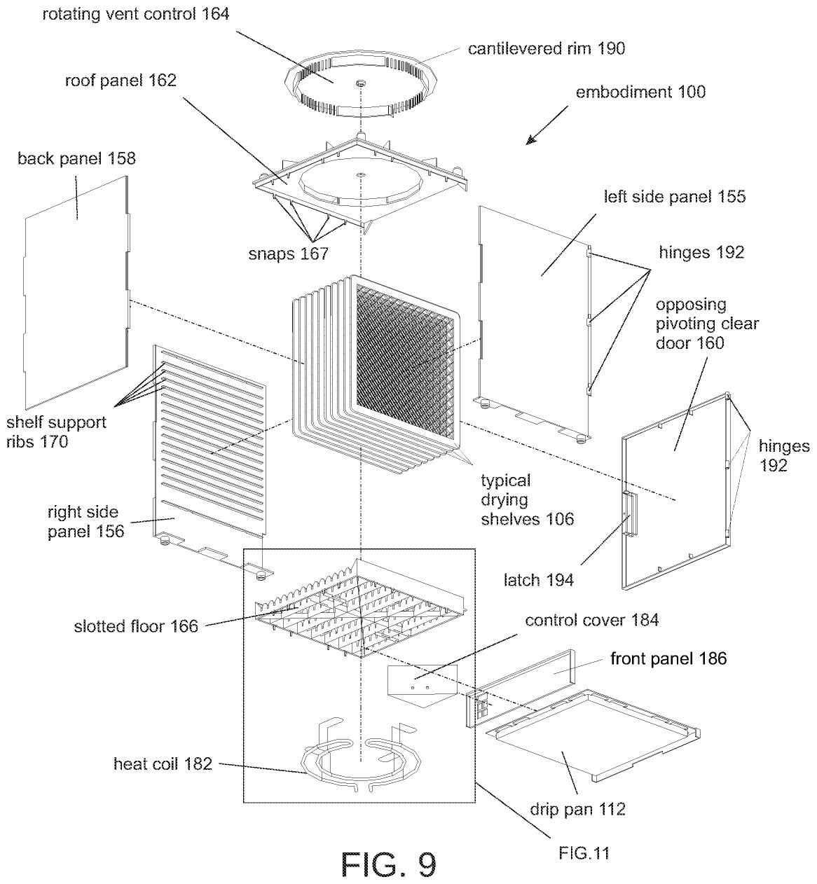

Silent, long-lasting operation, with no moving parts (FIGS. 8 and 9).

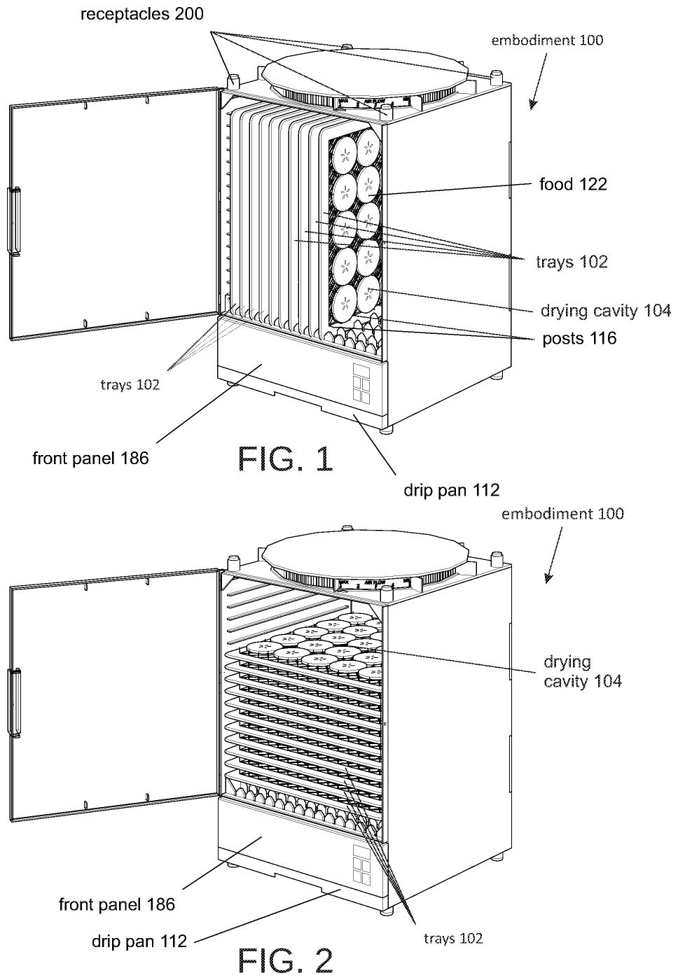

Easy operation with no tray rotations when trays are vertically oriented—FIG. 1, and precisely timed, one-step, “set it, and come and get it”™ convenience.

Vertical food suspension for quicker, more thorough and even drying (FIG. 1).

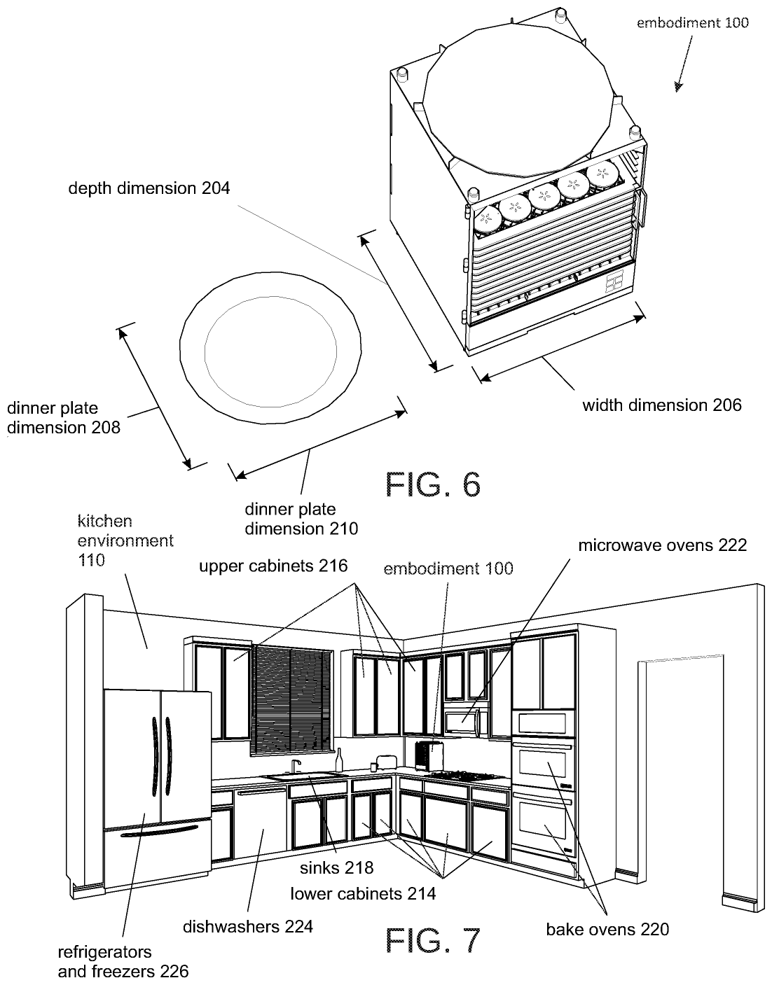

Dinner plate sized food drying shelves (FIG. 6) which fit into: above-countertop-cabinets, dishwashers, countertops, pantries, sinks, refrigerators and freezers, as well as other locations sized to fit a standard dinner plate.

Versatile shelves which may be used either when they are disposed vertically (FIG. 1) where, as a non-limiting and non-exhaustive examples, they mount such items as sliced meats, fish, fowl, fruits and vegetables, etc.; or when the shelves are disposed horizontally (FIG. 2), as a non-limiting and non-exhaustive examples, for fruit roll ups, herbs, nuts, raisins, seeds, flowers, yogurt cups, and other appropriate foods and items.

Rugged, inexpensive and reliable variable air venting (FIG. 10), to control the food drying environment.

Simplicity of construction, with limited parts, which in many cases, snap together (FIGS. 8 and 9).

Compactness in storage mode (FIG. 19).

Convenient use, with trays easily storing in standard sized zip bags (FIG. 5) without the need to unload the trays before storage, and without crushing the dried or processed foods, and other articles, in the bottoms of jars, bags, storage containers, etc.

Referring in particular to FIGS. 8 and 9, as well as other descriptions and figures herein, embodiment 100 includes left side panel 155, opposing right side panel 156, back panel 158, and opposing pivoting clear door 160.

Left side panel 155 snaps to back panel 158, which in turn snaps to right side panel 156. Pivoting clear door 160 removably mounts to left side panel 155 utilizing dismountable hinges 192 (FIG. 9). The three connected sidewalls 155, 158, and 156 are capped by roof panel 162, which snap fits 167 (FIGS. 9 and 10) to the side panels 155, 158, and 156.

Rotating vent control 164 fits coaxially around and over raised portion 238. Vent control 164 has cantilevered rim 190 projecting outward from its upper periphery (FIG. 10). When embodiment 100 is used outdoors or in other locations, cantilevered rim 190 helps protect rain and other liquids from falling into drying cavity 104 (FIG. 2) of embodiment 100.

Embodiment 100, besides being electrically energized, may be operated by placing it in sunlight, with or without electric power. This may be facilitated by at least one or more of side panels 155, 156, and 158 and/or roof panel 162, and/or door 160 being dark tinted or black, or a dark color, or translucent, or transparent.

Within the three sidewalls (155, 156, and 158) and pivoting clear door 160, typical drying shelves 106 are mounted in either a vertical disposition (FIG. 1) or a horizontal disposition (FIG. 2).

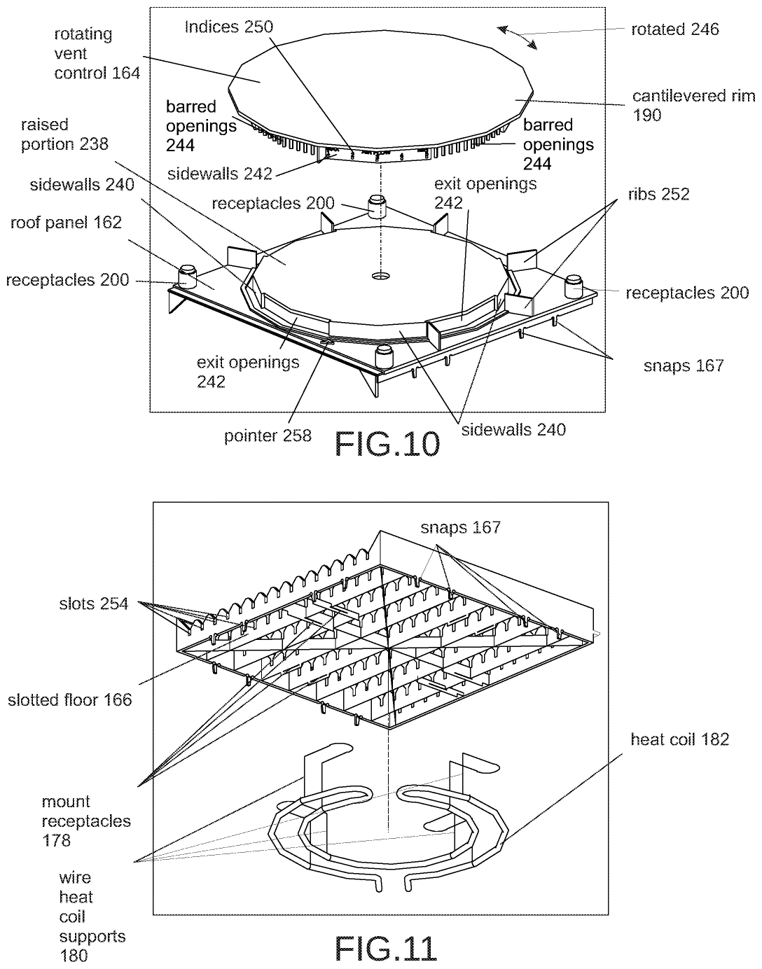

When typical drying shelves 106 are disposed in their vertical disposition (FIG. 1), they are supported and positioned laterally and vertically by sliding into slots 254 in slotted floor 166 (FIGS. 1 and 11), and they are further vertically positioned and supported by shelf support ribs 168 disposed on the inside face of back panel 158 (FIG. 8).

When typical drying shelves 106 are disposed in their horizontal disposition (FIG. 2), they are supported by shelf support ribs 170, positioned on the inner faces of both right side panel 156 and left side panel 155 (FIGS. 8 and 9).

Referring especially to FIGS. 13 through 17, typical drying shelf 106 has a perforated central portion 172 with an essentially flat first face 174 (FIG. 13), opposed by a second face 176 having posts 116 generally orthogonally projecting from second face 176 (FIG. 13).

Posts 116 may be used to mount and support food 122 in either typical drying shelf 106 vertical (FIG. 1) or horizontal (FIG. 2) dispositions.

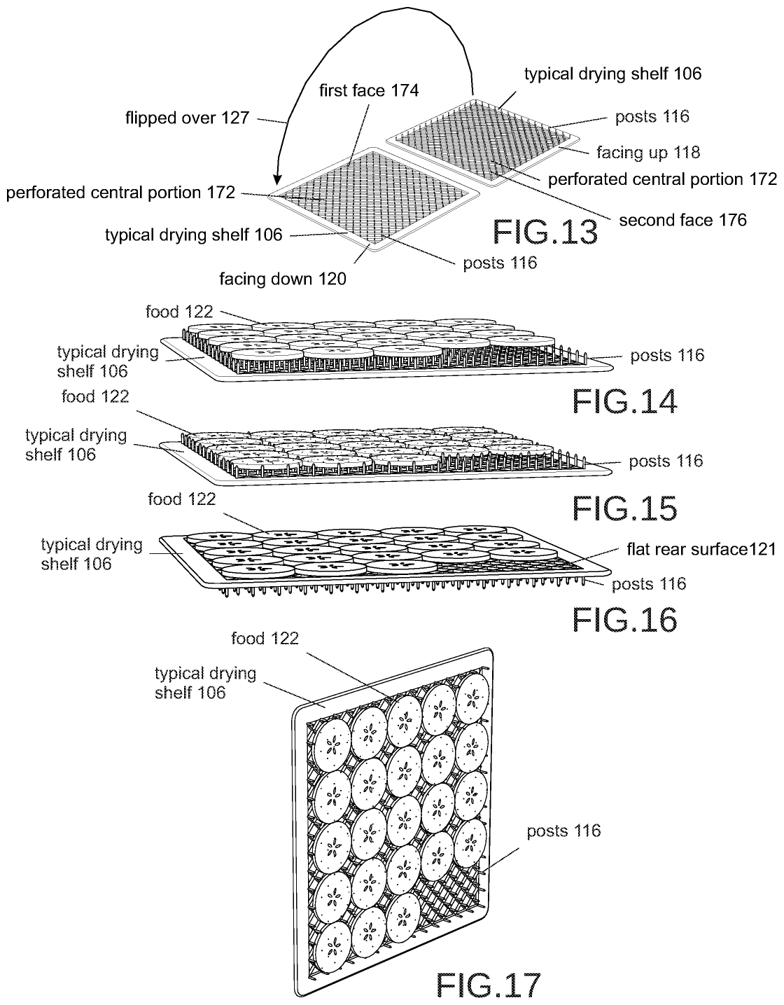

More specifically, in either horizontal (FIG. 2) or vertical (FIG. 1) dispositions, food 122 may be impaled onto posts 116 (FIGS. 15 and 17 respectively) to mount and support food 122 during its processing. Such a configuration might also be used during food storage.

Food 122 herein represents all different foods and other articles which may be processed inside of embodiment 100. As non-limiting and non-exhaustive examples, this may include: fruits, vegetables, meats, plants, herbs, foul, fish, seeds, raisins, flowers, fruit rollup trays 152, yogurt cups, etc. Each of these may be processed with embodiment 100 configured for vertical (FIG. 1) or horizontal (FIG. 2) operation, using each where appropriate.

In the horizontal disposition (FIG. 2), food may be mounted and supported on the upper tips of posts 116 (FIG. 14).

Also in the horizontal disposition (FIG. 2), food 122 may be mounted by resting it on the generally flat rear surface 121 (FIG. 16) of typical drying shelf 106.

Slotted floor 166 has on its underside, mount receptacles 178 (FIG. 11) which position and hold wire heat coil supports 180. Wire heat coil supports 180 in turn support and position heat coil 182.

Control cover 184, in cooperation with front panel 186 (FIGS. 8 and 9), house controls for the device, at least including a shut off timer.

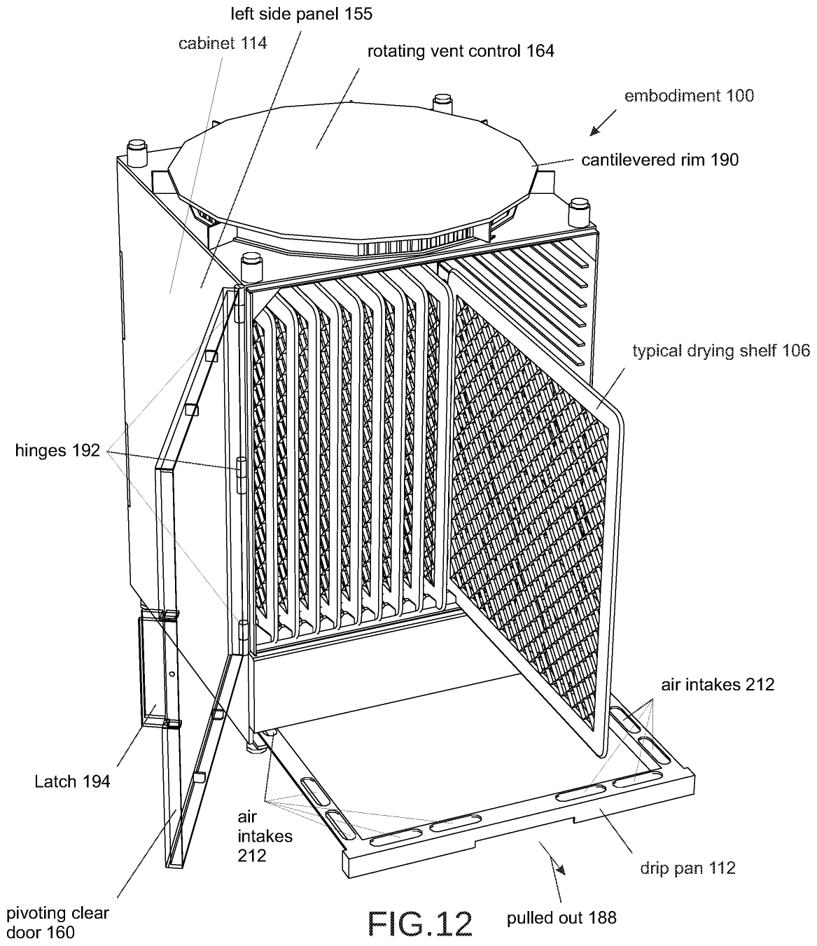

Drip pan 112 is slidably disposed below heat coil 182 (FIGS. 8, 9 and 12), and may be pulled out 188 (FIG. 12) and removed for cleaning or other purposes.

Pivoting clear door 160 connects to left side panel 155 via hinges 192. Hinges 192 are configured to pivot pivoting clear door 160 open and close, and to allow it to be lifted and fully removed (FIG. 9) for cleaning or access or other purposes.

Latch 194 holds pivoting clear door 160 closed (FIGS. 9 and 12).

### DETAILED DESCRIPTION

FIGS. 1 and 2 show two modes of operation for embodiment 100.

In FIG. 1, drying trays 106 are disposed vertically, with food 122 impaled on posts 116 (FIG. 17). This mode of operation offers at least: large capacity, rotation-free tray operation, even and fast drying, with limited mixing of food flavors.

In FIG. 2, drying trays 106 are disposed horizontally, with food 122 either resting on the upper tips of posts 116 (FIG. 14), or impaled on posts 116 (FIG. 15). This mode of operation allows flexibility to dry foods that don't adapt easily to vertical drying (FIG. 1), such as fruit roll ups, herbs, nuts, berries, seeds, yogurt cups, etc.

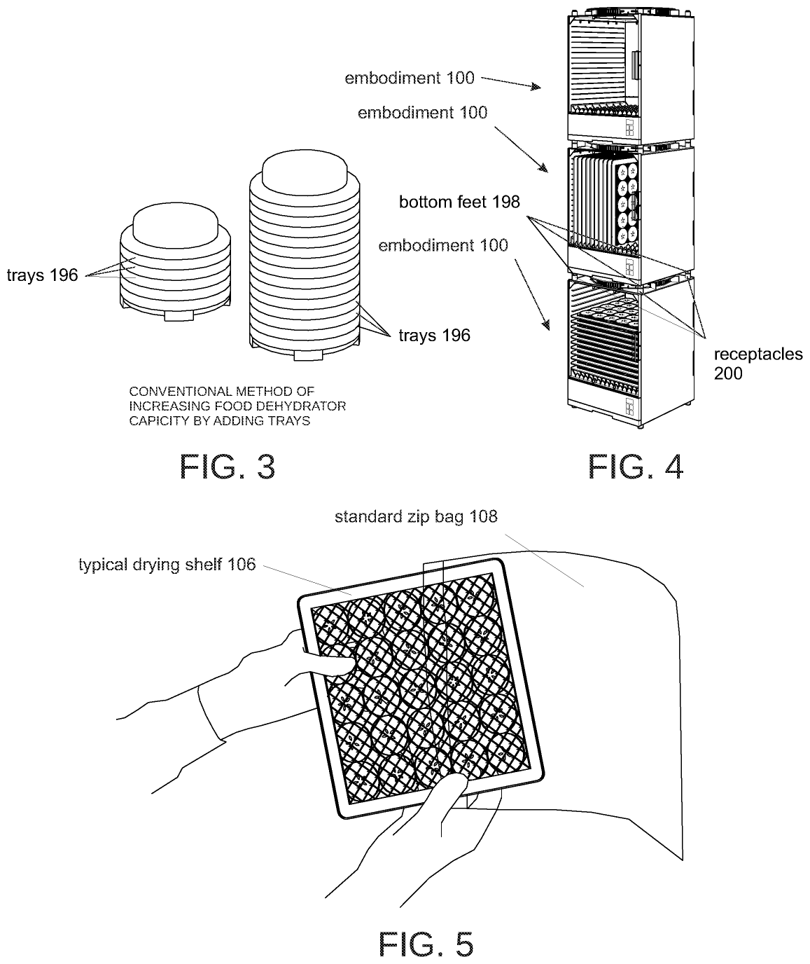

FIG. 3 shows how many current food dehydrators expand their capacity by stacking on additional drying trays 196. This method at least: increases drying times, causes unevenness in drying, and increases the need for tray rotation.

FIG. 4 shows how embodiment 100 may increase its capacity by being configured to stack one embodiment 100 on top of another. This, while increasing capacity, at least also maintains: the ease, quality, convenience and speed of drying. This configuration is accomplished through bottom feet 198 (FIG. 1) removably coupling with feet receptacles 200 (FIG. 1) located on the roof of embodiment 100.

Also improving this stacked configuration (FIG. 4), air intakes 212 (FIG. 12) are located in the corners of drip pan 112, whereas exit openings 242 (FIG. 10) are disposed in the centers of the edges, between the corners. Thus air exiting the exit openings 242 embodiment 100 which contains flavors and moisture from the lower stacked embodiment 100, is directed away from air intakes of the above stacked embodiment 100 where they might slow drying times and mix flavors on the above stacked embodiment 100.

FIG. 5 shows drying shelf 106 (also herein referred to as tray 102) being configured to efficiently store intact with food, inside of a standard plastic zip storage bag 108. As a non-limiting and non-exhaustive example, this may be a standard gallon sized zip plastic storage bag 106. This has several advantages over using storage jars, plastic bags alone, or other storage containers, at least because the dehydrated food isn't crushed to the bottom of the container, but rather dehydrated food is held flat and un-crushed by being impaled on posts 116 which protrude from drying shelf 106 (FIGS. 15 and 17).

This storage of food 122 while still attached to trays 102 is possible because the impaled engagement between posts 116 and food 122 prevents food 122 from sliding around during storage, as would occur on common flat trays.

Although embodiments of the present inventions may be made to any useful scale, ranging at least from much smaller than that shown to much larger, FIG. 6 compares the countertop footprint of a particularly useful sized embodiment 100 with a standard dinner plate having a diameter between 10¼ inches and 11¾ inches, with most sized at 11 inches. Depth dimension 204 and width dimension 206 for embodiment 100 are within ¼ of an inch of 11 inches in diameter (i.e between 10¾ inches and 11¼ inches).

This dinner plate size is particularly useful because many kitchen features, including: above countertop cabinets, dishwashers, countertops, refrigerators and freezers, dining tables, and many other kitchen features, are designed to accommodate dinner plate dimensions. Dehydrators which have a countertop footprint larger than a dinner plate, may not fit these kitchen features, and dehydrators which have a countertop footprint substantially smaller than a typical dinner plate, may make inefficient use of the space available in a typical kitchen.

To further optimize space utilization in a typical US kitchen, an embodiment might fit between a typical kitchen countertop and cabinets overhanging the countertop. In the US kitchen this distance usually is between 15½ inches and 16½ inches, with 16 inches being common.

FIG. 7 shows embodiment 100 in kitchen environment 110 showing its relative size to other kitchen elements, including, but not limited to: lower 214 and upper 216 cabinets, sinks 218, bake ovens 220, microwave ovens 222, dishwashers 224, refrigerators and freezers 226.

FIG. 8 shows an exploded view of embodiment 100 showing construction details from a forward viewpoint.

FIG. 9 shows an exploded view of embodiment 100 showing construction details from a rear perspective.

FIG. 10 is an enlarged detail of FIG. 8, as indicated in FIG. 8, showing details of how air is exited in a controlled manner from drying cavity 104 (FIG. 2), and thus one way the dehydrating environment may be controlled to affect dehydration outcomes. Roof panel 162 has raised portion 238, including downward, generally cylindrical, sidewalls 240 which have four approximately 45° exit openings 242 equally spaced on its periphery.

Rotating vent control 164 snaps over, and coaxially rotates around, raised portion 238. Rotating vent control 164 has generally cylindrical and downward facing sidewalls 242, including four generally equally spaced barred openings 244, which intermittently cover exit openings 242 when rotating vent control 164 is rotated 246. The amount of coverage controls the amount of air exiting through exit openings 242, and thus the amount of airflow through embodiment 100 which in turn controls the drying environment within drying cavity 104.

Indices 250 and pointer 258 communicate to the user the directed amount of airflow through drying cavity 104.

Ribs 252 direct air existing through exit openings 242 to the central portion of each side of roof panel 162. When one embodiment 100 is stacked on a second embodiment 100 (FIG. 4), air intakes 212 (FIG. 12) cause the upper embodiment 100 to pull air in on its lower corners, generally 45° away from where air is exiting from the lower embodiment 100. This allows the upper embodiment 100 to pull in clean dry air, and not moist air contaminated with food flavors from the lower embodiment 100.

FIG. 11 is a detail of FIG. 9, as indicated in FIG. 9. It shows upward facing slots 254 which support and position trays 102 when they are in their vertical disposition (FIG. 1). It also shows mount receptacles 178 which engage wire coil supports 180, in order to hold and position heat coil 182 within embodiment 100.

Slotted floor 166, as with roof panel 162, snap into 167 side panels 155, 156, and 158 (FIG. 8) at least to provide structure.

As shown in FIG. 12, when pivoting clear door 160 is open, trays 102, also referred to herein as typical drying shelf 106, may be pulled out of embodiment 100.

Drip pan 112 also may be pulled out 188 and fully removed from embodiment 100 for cleaning or other purposes.

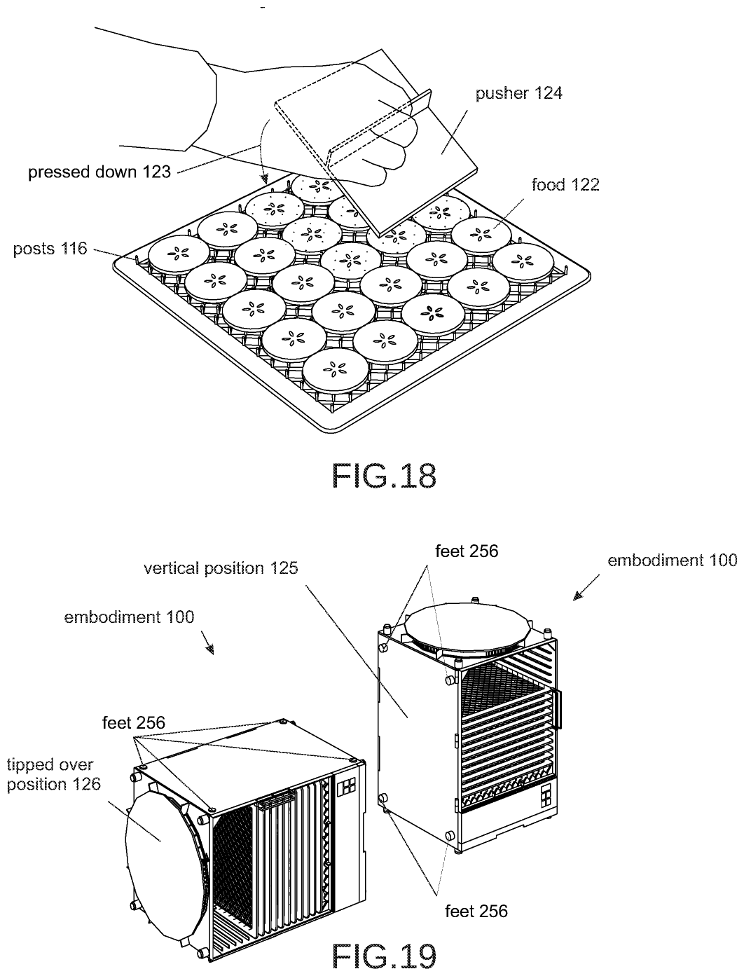

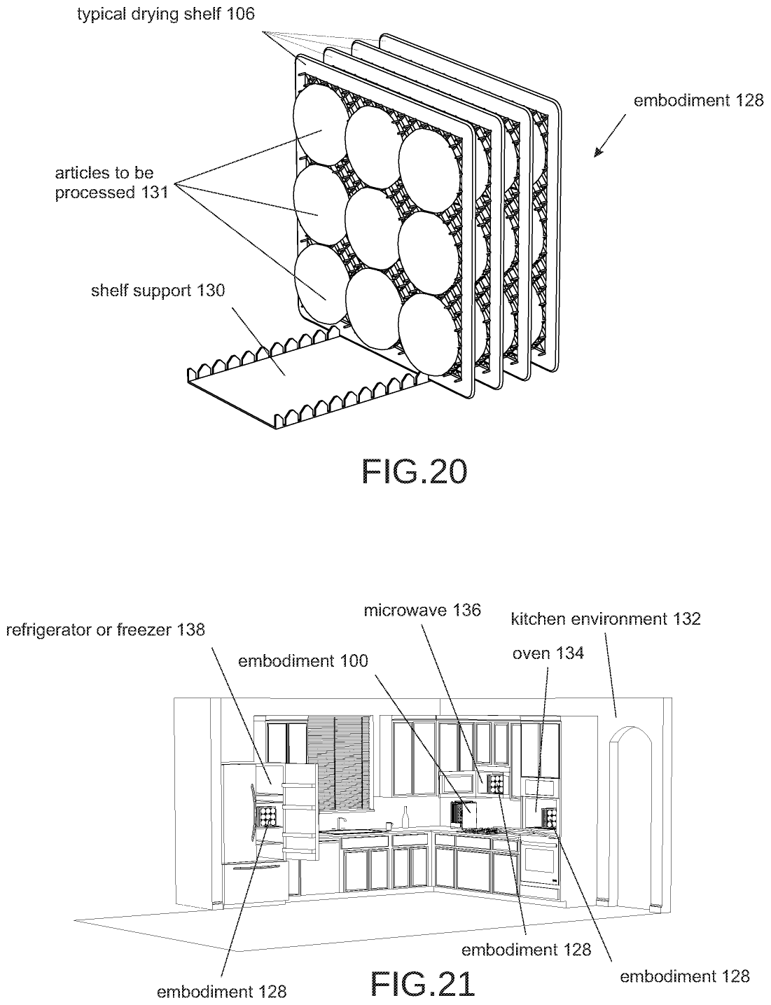

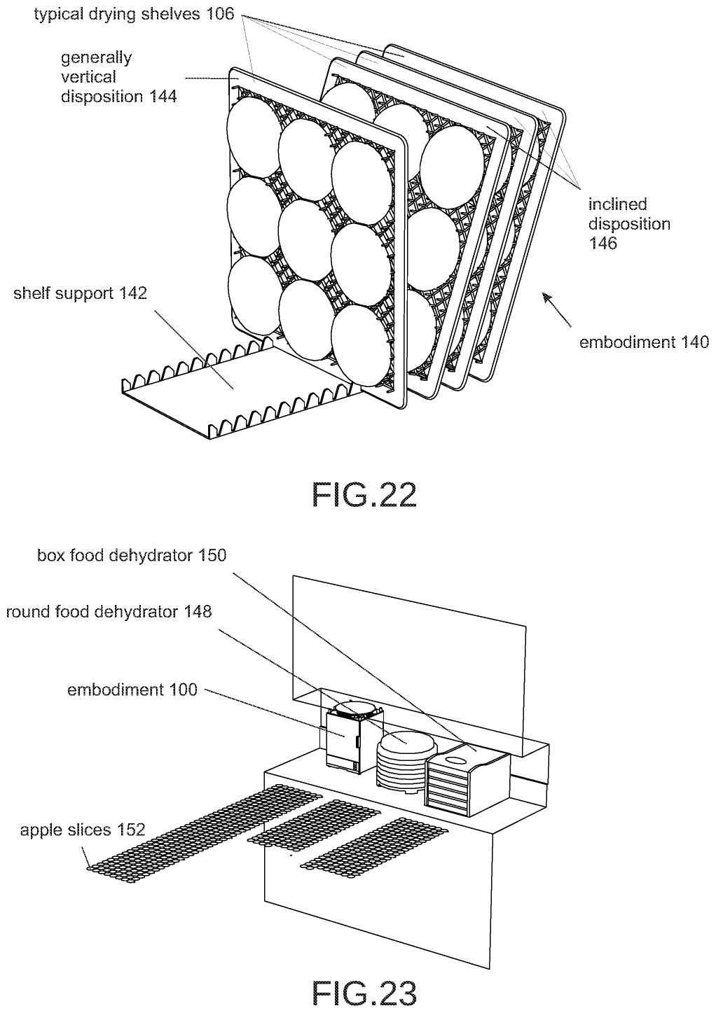

FIG. 18 shows how pusher 124 might be used to impale food 122, as well as other articles, onto posts 116. Such items are first loosely placed onto the upper tips of posts 116, and then downward pressure 123 on pusher 124 forces the items to be impaled, by the posts 116 (FIGS. 15 and 17).

As an alternative, or used in conjunction, with pusher 124, food 122, as well as other articles may be placed onto the upper tips of posts 116 of two or more tray 102s, and the trays 102 stacked on top of one another. Downward pressure on the uppermost tray 102 in the stack, causes all food 122 and/or other articles to be impaled on all trays simultaneously.

FIG. 19 shows how feet 256 disposed on the outer face of left side panel 155, or on the outer face of right side panel 156, or on the outer face of back panel 158, might allow embodiment 100 to be stored on its side or back, thus reducing storage shelf height requirements.

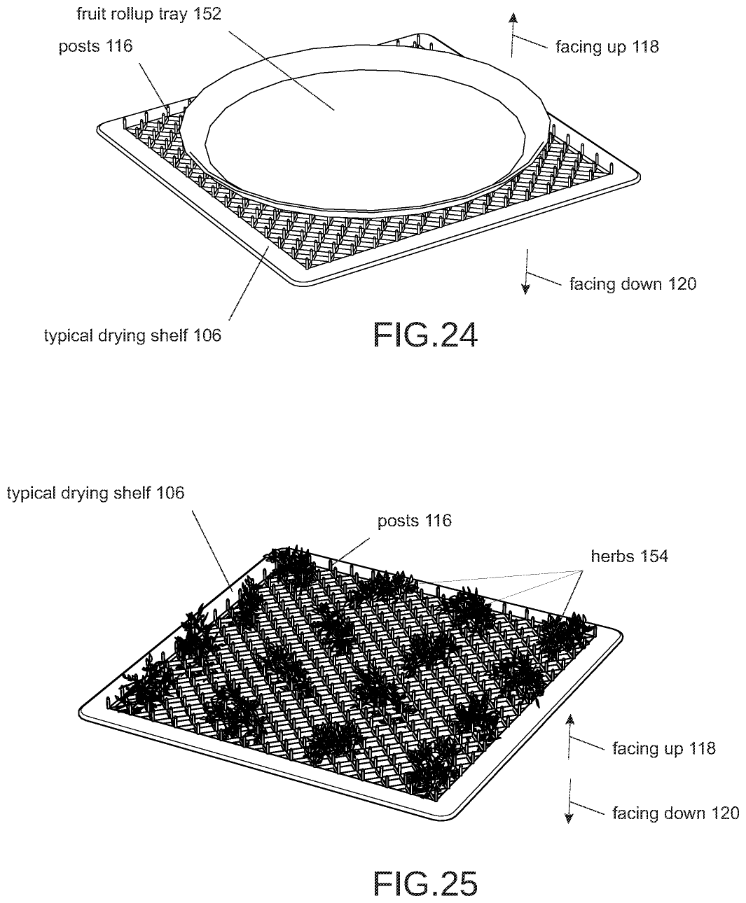

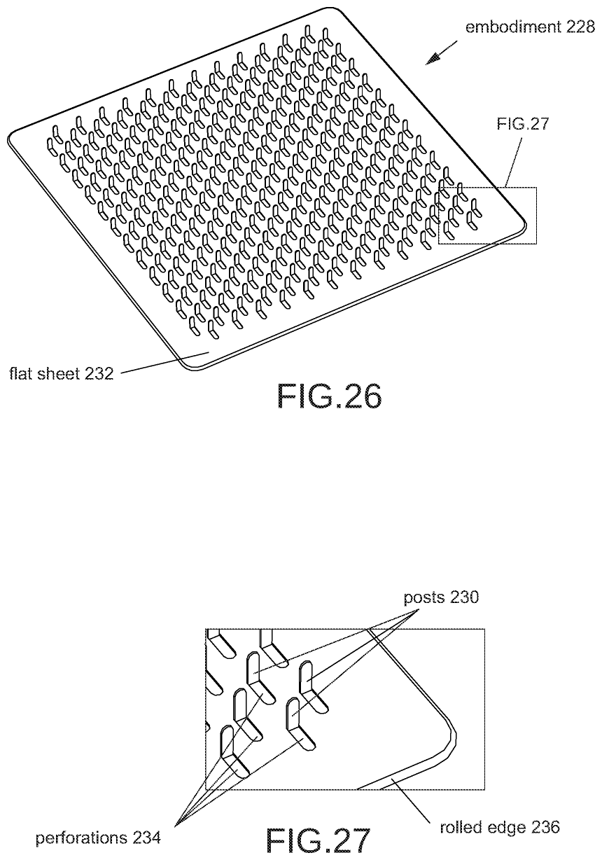

FIG. 24 shows how dehydration accessories, including fruit rollup tray 152, as well as parchment, yogurt cups, and others, might have improved airflow, and thus operate more efficiently, by each resting on the upper tips of posts 116.

FIG. 25 shows how herbs 154, as well as other articles, might also benefit from the improved airflow provided by upward facing posts 116.

1. A device to secure comestibles and other items within a food preparation environment, comprising:
an enclosure;
means to provide a food preparation environment within the enclosure;
a tray including a generally flat substrate with a plurality of posts projecting substantially orthogonally from the generally flat substrate; and
the posts being configured to support and position foods and other items within the enclosure.

2. The device of claim 1, wherein the tray is configured to be disposed horizontally within the enclosure.

3. The device of claim 1, wherein the tray is configured to be disposed vertically within the enclosure.

4. The device of claim 1, wherein the tray is configured to be disposed diagonally within the enclosure.

5. The device of claim 1, wherein the tray is configured to be, at times, disposed vertically, and at other times to be disposed horizontally within the enclosure.

6. The device of claim 1, wherein the posts are configured to impale food while the food is being supported and positioned by the posts.

7. The device of claim 1, wherein the posts are configured not to impale food while the food is being positioned and supported by the posts.

8. The device of claim 1, wherein the posts are configured to selectively impale food or not impale food while the food is being positioned and supported by the posts.

9. The device of claim 1, wherein the means to provide a food preparation environment within the enclosure, is configured to create an environment to dehydrate food or other articles while they are in the enclosure.

10. The device of claim 1, wherein the means to provide a food preparation environment within the enclosure, is configured to create an environment which oven, or convection oven, cooks food while it is in the enclosure.

11. The device of claim 1, wherein the means to provide a food preparation environment within the enclosure, is configured to create an environment which microwave cooks food within the enclosure.

12. The device of claim 1, further comprising a plurality of trays.

13. A food dehydration device configured to increase capacity while maintaining its dehydration quality and while maintaining its countertop footprint, comprising:
a first enclosure, including means to position foods within the first enclosure; and
the first enclosure also including means to create a dehydration environment within the first enclosure; and
the first enclosure having enclosure supports extending from its bottom; and
the first enclosure having coupling points positioned on its top; and
the coupling points configured to engage the enclosure supports;
whereby capacity is selectively increased, and the dehydrating quality and countertop footprint preserved, by a second enclosure, which is constructed substantially identical to the first enclosure, being placed on top of the first enclosure, and engaging the first enclosure through the enclosure supports of the second enclosure engaging the coupling positions of the first enclosure.

14. The dehydration device of 13, wherein, when the first enclosure is disposed above the second enclosure, the enclosures are configured to prevent air exiting the second enclosure from entering into the first enclosure.

15. A device to make storing dehydrated foods comprising: a food dehydrator tray having a plurality of generally orthogonally projecting posts, the posts being configured to impale food placed on the tray, and the tray being sized to fit within a conventional plastic zip storage bag concurrent with the tray holding dehydrated food, or other articles impaled on the posts.

16. The device of claim 15, wherein the conventional plastic zip storage bag is comprised of a gallon size storage bag.

17. A food dehydrator adapted to be used in a kitchen and the food dehydrator having a plan view width and depth which matches a standard dinner plate, and wherein the food dehydrator has a height which clears typical over-counter kitchen cabinets.

18. The food dehydrator of claim 17, wherein the food dehydrator has both a width and a depth between 10¼ inches and 11¾ inches.

19. The food dehydrator of claim 18, wherein the food dehydrator also has a height less than 16 inches.

20. A method to mount food and other articles onto a generally flat tray, and the tray having posts projecting substantially orthogonally from a generally flat tray surface, and the method comprising the steps of:
placing the tray on a support surface with its posts facing away from the support surface;
placing the food and/or other articles to be mounted, onto the end tips of the posts; and
using a handheld planar pusher, pushing down on the food to impale the food on the posts.

21. A method to mount food and other articles onto a generally flat tray, and the tray having posts projecting substantially orthogonally from a substantially flat tray surface of the generally flat tray, and the method comprising the steps of:
placing a first tray onto a support surface with its posts facing away from the support surface;
placing the food and/or other articles to be mounted, onto the end tips of the posts of the first tray;
placing a second tray on top of food resting on the posts of the first tray;
repeating the above step as necessary, thus creating a stack of trays, with food resting on the end tips of posts of each tray; and
placing downward pressure on the uppermost tray on the stack of trays, and thus causing food resting on the end tips of the posts, to be impaled onto the posts.

22. A food dehydrator with versatility to fit kitchen storage areas, comprising:
a food dehydrator having at least one unequal: length, width, or depth dimensions;
the food dehydrator, including an enclosure having a floor, sidewalls, and a top; and
the floor and one sidewall having support feet;
whereby, the enclosure is configured to be supported in a first operating position by the floor support feet, and is configured to be supported in a second storage position by the sidewall support feet, the second storage position being disposed 90° from the first operating position.

23. A food support configured to hold comestibles and other items in a food preparation environment, comprising:
a tray, having substantially flat front and back faces, and a plurality of posts projecting from one of the faces;
the plurality of posts configured to impale comestibles and other items, and thus support and position them within a food preparation environment; and
a tray support configured to support and position the tray within a food preparation environment, in a disposition between 30° and 90° off horizontal.
